(19) United States
(12) Patent Application Publication
(10) Pub. No.: US 2026/0191169 A1
(43) Pub. Date: Jul. 9, 2026

(54) PET GROOMING MACHINE

(71) Applicant: JIANGSU ERLANGSHEN PLASTIC CO., LTD, YANGZHOU (CN)

(72) Inventors: Yuan Gong, Yangzhou (CN); Kang Zhao, Yangzhou (CN)

(73) Assignee: JIANGSU ERLANGSHEN PLASTIC CO., LTD, YANGZHOU (CN)

(21) Appl. No.: 19/561,885

(22) Filed: Mar. 10, 2026

Related U.S. Application Data
(63) Continuation of application No. PCT/CN2024/083381, filed on Mar. 22, 2024.

(30) Foreign Application Priority Data
May 15, 2023 (CN) 2023211650116

(51) Int. Cl. A01K 13/00

(52) U.S. Cl. CPC A01K 13/001

(57) ABSTRACT

The disclosure provides a pet grooming machine, which comprises a housing and a motor located within the housing. The housing includes an outer shell and an inner shell. The outer shell is provided with a first air inlet and a second air inlet, while the inner shell is equipped with a third air inlet, a fourth air inlet, and an air outlet located on the lower side of the inner shell. In the pet grooming machine of this utility model, when grooming a pet's fur, the motor starts to draw air from the first air inlet and the third air inlet into the housing and expel it from the air outlet of the inner shell. When the air duct is blocked, by pressing the inner shell, the second air inlet and the fourth air inlet become connected, and the first air inlet and the third air inlet are blocked.

### CROSS REFERENCE TO RELATED APPLICATION

The disclosure is a Continuation of PCT Patent Application No. PCT/CN2024/083381, filed on March 22, 2024, which claims priority of China Patent Application No. CN202321165011. 6 filed on May 15, 2023. The contents of the above-identified applications are incorporated herein by reference.

### TECHNICAL FIELD

The disclosure relates to the technical field of pet supplies, and more particular to a pet grooming machine.

### BACKGROUND

With the societal development and the improvement of living standards, pet ownership has become increasingly prevalent among the general public. Mainstream companion animals such as cats and dogs routinely require fur cleaning and washing. Conventional pet grooming machine in the prior art are typically configured with a single air duct, which is susceptible to clogging during operation and thus results in subpar grooming performance. Such clogging readily causes pet fur to become entangled inside the grooming device, which necessitates manual cleaning of the device before subsequent grooming operations can be performed. This not only leads to cumbersome cleaning procedures but also compromises the overall usability of the device.

Therefore, there remains room for improving the pet fur grooming device.

### SUMMARY

### Technical Problems

The disclosure provides a pet grooming machine to solve the problems of easy blockage, hair entanglement, cumbersome cleaning, and inconvenient use in pet grooming machines of the prior art.

### Technical Solution

To solve the aforementioned technical problems, the technical solution of the disclosure is as follows: the pet grooming machine comprises a housing and a motor located inside the housing. The housing includes an outer shell, and an inner shell moving relative to the outer shell along a movement stroke. The outer shell defines a first air inlet and a second air inlet that are misaligned. The inner shell defines: a third air inlet in communication with the first air inlet; a fourth air inlet arranged in accordance with the movement stroke and corresponding to the second air inlet; and an air outlet arranged on a lower side of the inner shell. Wherein, moving the inner shell selectively places either the first air inlet in communication with the third air inlet or the second air inlet in communication with the fourth air inlet.

In the disclosure, the first air inlet and the second air inlet are opposite each other, and the third air inlet and said fourth air inlet are arranged diagonally.

In the disclosure, the outer shell comprises a first through-tube, a second through-tube disposed within the first through-tube, and a plurality of first connecting columns connecting the second through-tube to the first through-tube.

In the disclosure, the second through-tube further includes an installation plate for fixing the motor, and a plurality of second connecting columns connecting the installation plate within the second through-tube.

In the disclosure, the housing further comprises an air outlet tube connected to one side of the second through-tube, with a first air outlet disposed on the peripheral side of the air outlet tube.

In the disclosure, the bottom of the inner shell is provided with a concave and hollow cylinder, connected to the installation plate, and the air outlet is disposed on the cylinder.

In the disclosure, the air outlet comprises a second air outlet and a third air outlet arranged diagonally relative to each other.

In the disclosure, the housing further comprises an upper cover detachably connected to a top of the first through-tube.

In the disclosure, a diameter of the cylinder is smaller than that of the air outlet tube, and the cylinder is connected within the air outlet tube.

In the disclosure, the cylinder has a length greater than that of the air outlet tube and is telescopically connected within the air outlet tube.

### Beneficial Effects

Compared with the prior art, the beneficial effects of the disclosure are as follows: during pet fur grooming, the motor of the pet grooming machine of the disclosure is activated to draw air from the first and third air inlets into the housing and expel it through the exhaust port of the inner shell. When the air duct is blocked, pressing the inner shell allows the second and fourth air inlets to communicate, while the first and third air inlets are sealed. The motor then draws air from the second and fourth air inlets and expels it through the exhaust port. The dual-air duct design enables switching to another air duct for continued pet fur cleaning when one air duct is blocked by pet fur, eliminating the immediate need to clean the pet grooming machine. This allows for effective and rapid pet grooming, making it more convenient to use.

### BRIEF DESCRIPTION OF THE DRAWINGS

To more clearly illustrate the technical solutions in the embodiments of the disclosure or in the prior art, a brief introduction to the drawings used in the embodiments is provided below. The drawings described below are only corresponding drawings of some embodiments of the disclosure.

FIG. 1 is a perspective view of a pet grooming machine in accordance with an embodiment of the disclosure.

FIG. 2 is a perspective view of an outer shell of the pet grooming machine in accordance with an embodiment of the disclosure.

FIG. 3 is another perspective view of the outer shell of the pet grooming machine in accordance with an embodiment of the disclosure.

FIG. 4 is a perspective view of an inner shell of the pet grooming machine in accordance with an embodiment of the disclosure.

FIG. 5 is another perspective view of the inner shell of the pet grooming machine in accordance with an embodiment of the disclosure.

FIG. 6 is a perspective view of the air outlet pipe of the pet grooming machine in accordance with an embodiment of the disclosure.

FIG. 7 is a first sectional view of the pet grooming machine in accordance with an embodiment of the disclosure.

FIG. 8 is a second sectional view of the pet grooming machine in accordance with an embodiment of the disclosure.

### DETAILED DESCRIPTION OF THE EMBODIMENTS

To make the objectives, technical solutions, and advantages of the embodiments of the present disclosure clearer, the technical solutions in the embodiments of the present disclosure will be described clearly and completely hereinafter with reference to the accompanying drawings of the embodiments of the present disclosure. It is obvious that the described embodiments are part of rather than all of the embodiments of the present disclosure. Based on the embodiments provided in the present disclosure, all other embodiments obtained by those of ordinary skill in the art without creative efforts shall fall within the protection scope of the present disclosure.

Unless otherwise defined, technical or scientific terms used herein shall have the ordinary meaning as understood by a person skilled in the art to which this disclosure pertains.

The terms “first,” “second,” and similar terms used in the specification and claims of the present disclosure do not denote any order, quantity, or significance, but are merely used to distinguish different components. Terms such as “include” or “comprise” mean that the elements or objects preceding such terms encompass the elements or objects listed thereafter and their equivalents, without excluding other elements or objects. Terms such as “connect” or “connected” are not restricted to physical or mechanical connections, but may also include electrical connections whether direct or indirect. Terms such as “upper,” “lower,” “left,” and “right” are used merely to indicate relative positional relationships, and such relative positional relationships may change accordingly when the absolute position of the described object changes.

The technical solutions of the embodiments of the present disclosure are described clearly and completely hereinafter with reference to the accompanying drawings. It is evident that the described embodiments are only part of the present disclosure, not all thereof. All other embodiments obtained by those skilled in the art based on the present disclosure without creative effort shall fall within the protection scope of the present disclosure.

The following describes an embodiment of a pet grooming machine provided by the disclosure, which can solve the technical problems described above.

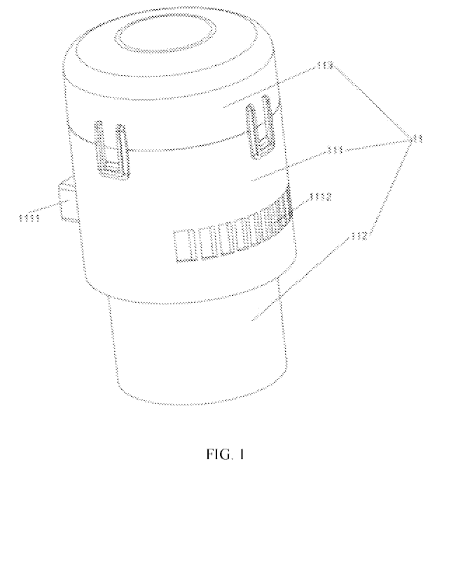

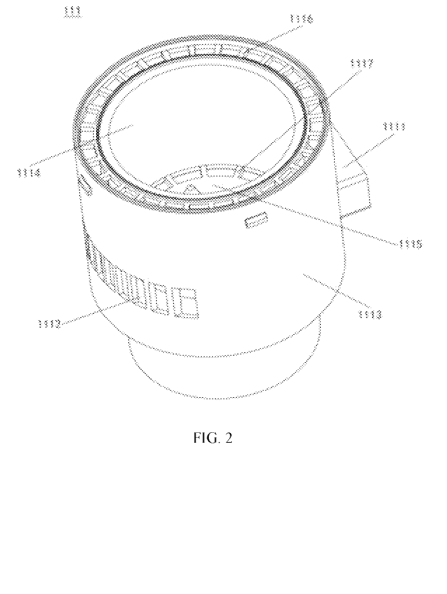

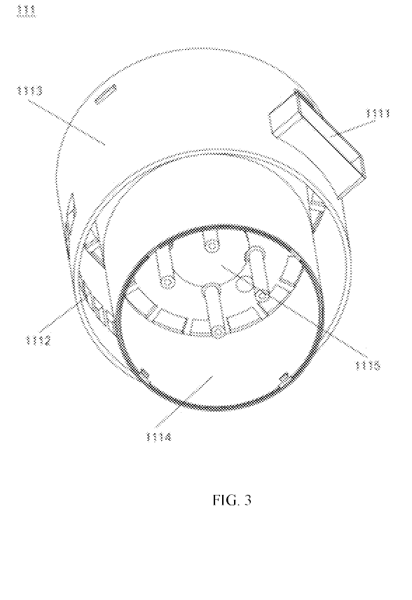

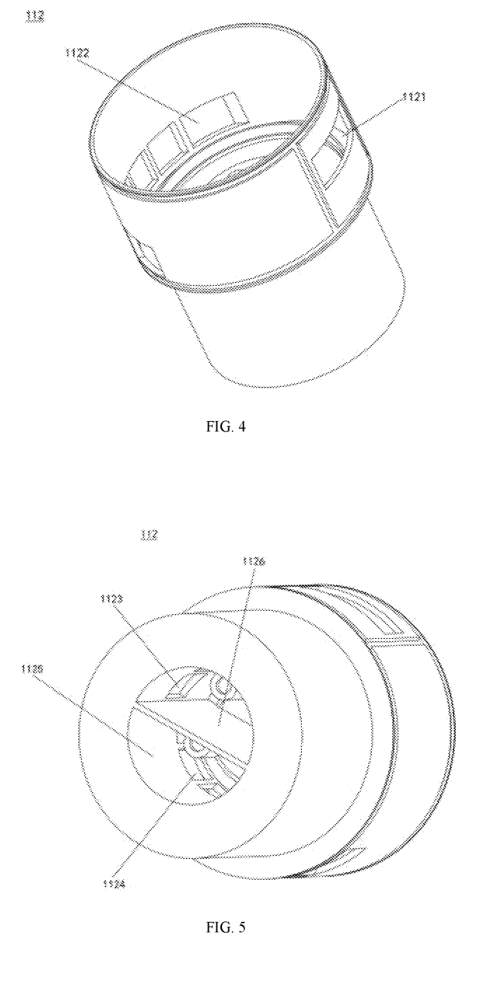

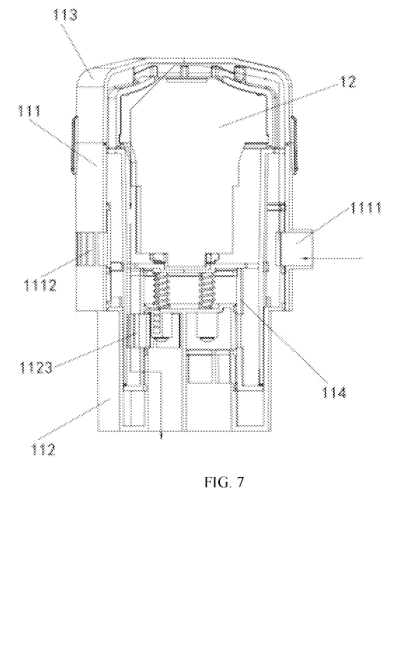

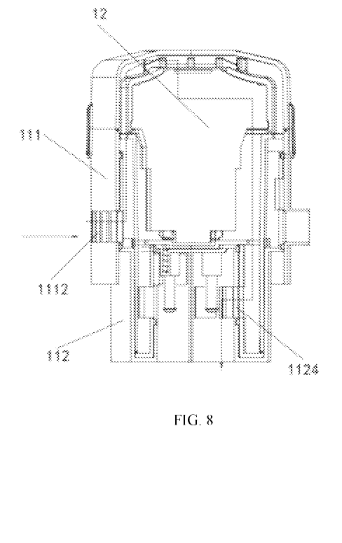

Referring to FIGS. 1, 2, 3, 4, 7, and 8, wherein FIG. 1 is a perspective view of the pet grooming machine of the disclosure; FIG. 2 is a perspective view of the outer shell of the pet grooming machine of the disclosure; FIG. 3 is another perspective view of the outer shell of the pet grooming machine of the disclosure; FIG. 4 is a perspective view of the inner shell of the pet grooming machine of the disclosure; FIG. 7 is a sectional view 1 of the pet grooming machine of the disclosure; and FIG. 8 is a sectional view 2 of the pet grooming machine of the disclosure.

In the drawings, like structural elements are designated by like reference numbers.

The terms “first,” “second,” and the like in the present disclosure are used for descriptive purposes only. They are not intended to indicate or imply relative importance, nor to impose order or sequence.

The pet grooming machine provided by the present disclosure includes a housing 11 and a motor 12 disposed within the housing 11. The housing 11 comprises an outer shell 111 and an inner shell 112 movable relative to the outer shell 111 with a movement stroke therebetween. The outer shell 111 is formed with a first air inlet 1111 and a second air inlet 1112 that are staggered. The inner shell 112 is formed with a third air inlet 1121, a fourth air inlet 1122 arranged to correspond to the movement stroke relative to the second air inlet 1112, and an air outlet disposed at a lower side of the inner shell 112. The inner shell 112 is movable such that the first air inlet 1111 is in communication with the third air inlet 1121, or the second air inlet 1112 is in communication with the fourth air inlet 1122. The motor 12 is configured to draw air from outside the housing 11 through either the first air inlet 1111 or the second air inlet 1112, and to expel the air through the air outlet at the lower side of the inner shell 112. During pet fur grooming, the first air inlet 1111 of the outer shell 111 is in communication with the third air inlet 1121 of the inner shell 112. Upon activation of the motor, air is drawn through the first air inlet 111 and the third air inlet 1121, thereby drawing loose pet fur into the housing 11 through the first air inlet 1111. The drawn air flows through the motor 12 and is expelled from the air outlet of the inner shell 112 moves relative to the outer shell 111 along the movement stroke. In this position, a side wall of the inner shell 112 blocks the first air inlet 1112 of the outer shell 111 communicates with the fourth air inlet 1122 of the inner shell 112. Upon activation of the motor 12, air is drawn through the second air inlet 112 and the fourth air inlet 1122, flows through the motor 12, and is expelled from the air outlet of the inner shell 112. If one air duct is blocked with pet fur during grooming, the user may press and move the inner shell 112 to the movement stroke to switch to the other air duct and continue grooming. The dual-air-duct configuration allows continuous grooming operation without immediate cleaning when one air duct is blocked, thereby improving efficiency and convenient in use.

The first air inlet 1111 and the second air inlet 1112 are arranged opposite to each other, and the third air inlet 1121 and the fourth air inlet 1122 are arranged diagonally. When the first air inlet 1111 is in communication with the third air inlet 1121, a side wall of the outer shell 111 blocks the fourth air inlet 1122, and the side wall of the inner shell 112 blocks the second air inlet 1112, thereby effectively preventing air from entering through the second air inlet 1112. When the inner shell 112 moves along the movement stroke, the side wall of the inner shell 112 blocks the first air inlet 1111, the side wall of the outer shell 111 blocks the third air inlet 1121, and the second air inlet 1112 of the outer shell 111 is in communication with the fourth air inlet 1122 of the inner shell 112, thus completing the air duct switching.

The outer shell 111 includes a first through tube 1113, a second through tube 1114 disposed within the first through tube 1113, and a plurality of first connecting columns 1116 configured to connect the second through tube 1114 to the first through tube 1113. An air chamber is formed between the first through tube 1113 and the second through tube 1114 to facilitate the flow of air entering the outer shell 111 towards the motor 12. Openings are formed on both sides of the first connecting columns 1116, which not only allows air circulation but also effectively prevents fur from moving toward the motor12.

The second through tube 1114 is further provided therein with a mounting plate 1115 for fixing the motor 12 and a plurality of second connecting columns 1117 for connecting the mounting plate 1115. Openings are formed on both sides of the second connecting columns 1117 to facilitate air circulation toward the lower portion of the second through tube 1114.

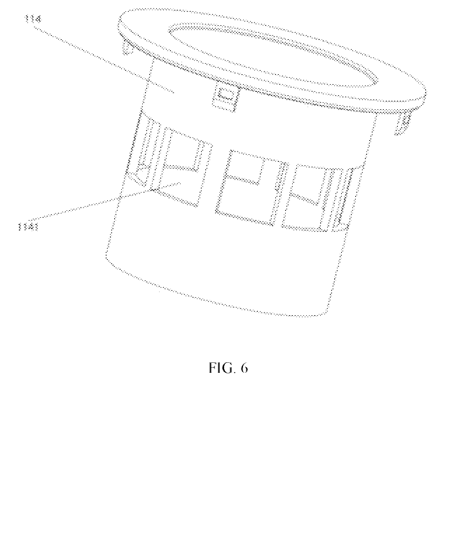

Referring to FIG. 6, which is a perspective view of the air outlet tube of the pet grooming machine of the disclosure. The housing 11 further includes an air outlet tube 114 connected to one side of the second through tube 1114. A first air outlet 1141 is formed at a periphery of the air outlet tube 114. The air outlet tube 114 is configured to connect with the inner shell 112, and is further operable, when the motor 12 is running, to expel air inside the inner shell 112 outward through the first air outlet 1141.

Referring to FIG. 5, which is a perspective view of the inner shell of the pet grooming machine of the present disclosure. The bottom of the inner shell 112 is provided with a concave hollow cylinder 1125. The cylinder 1125 is connected to the mounting plate 1115, and the air outlet is disposed on the cylinder 1125. The cylinder 1125 is configured to connect with the mounting plate 1115, thereby preventing the inner shell 112 from being separated from the outer shell 111.

The air outlet includes a second air outlet 1123 and a third air outlet 1124 arranged diagonally. When the first air inlet 1111 is in communication with the third air inlet 1121, the second air outlet 1123 is in communication with the first air outlet 1141, while the third air outlet 1124 is blocked by the side wall of the air outlet tube 114. When the inner shell 112 moves to the movement stroke, the third air outlet 1124 is in communication with the first air outlet 1141, while the second air outlet 1123 is blocked by the side wall of the air outlet tube 114.

The housing 11 further includes an upper cover 113 detachably connected to the top of the first through tube 1113, to facilitate cleaning of pet fur accumulated on the first connecting columns 1116.

The diameter of the cylinder 1125 is smaller than that of the air outlet tube 114. The cylinder 1125 is received within the air outlet tube 114 to limit the movement direction of the inner shell 112 and prevent positional deviation thereof during movement.

The length of the cylinder 1125 is greater than that of the air outlet tube 114. The cylinder 1125 is telescopically received within the air outlet tube 114, thereby guiding movement of the inner shell 112 and preventing the air outlet tube 114 from interfering with movement of the cylinder 1125.

In this embodiment, a baffle 1126 is disposed inside the cylinder 1125 to separate the second air outlet 1123 and the third air outlet 1124. The baffle 1126 is configured to prevent cross-flow between air discharged from the second air outlet 1123 and air discharged from the third air outlet 1124.

### Working Principle:

The pet grooming machine includes a housing 11 and a motor 12 disposed within the housing 11. The housing 11 includes an outer shell 111, an inner shell 112 disposed within the outer shell 111 and movable relative thereto, an upper cover 113 detachably coupled to a top portion of the outer shell 111, and an air outlet tube 114 connected to a bottom portion of the outer shell 111 and extending into the inner shell 112. The outer shell 111 includes a first through tube 1113, a second through tube 1114 disposed within the first through tube 1113, a plurality of first connecting columns 1116 for connecting the second through tube 1114 to the first through tube 1113, a mounting plate 1115 disposed within the second through tube 1114, and a plurality of second connecting columns 1117 for securing the mounting plate 1115 within the second through tube 1114. The air outlet tube 114 is connected to a lower portion of the second through tube 1114, and a first air outlet 1141 is disposed at a periphery of the air outlet tube 114. The first through tube 1113 is formed with a first air inlet 1111 and a second air inlet 1112 that are oppositely arranged. A concave hollow cylinder 1125 is disposed at a bottom portion of the inner shell 112 and coupled to the mounting plate 1115. The cylinder 1125 is formed with air outlets including a second air outlet 1123 and a third air outlet 1124 that are diagonally arranged. A third air inlet 1121 and a fourth air inlet 1122, which are diagonally arranged, are disposed at an upper portion of the inner shell 112. A baffle 1126 is further disposed inside the cylinder 1125 to separate the second air outlet 1123 and the third air outlet 1124. The diameter of the cylinder 1125 is smaller than that of the air outlet tube 114, and the cylinder 1125 is received within the air outlet tube 114.

During pet fur grooming, the first air inlet 1111 is in communication with the third air inlet 1121, and the second air outlet 1123 is in communication with the first air outlet 1141. The side wall of the inner shell 112 blocks the second air inlet 1112 of the outer shell 111, and the side wall of the outer shell 111 blocks the fourth air inlet 1122 of the inner shell 112. When the motor 12 operates, the motor 12 draws in air that enters sequentially through the first air inlet 1111 and the third air inlet 1121. The incoming air passes through a gap between the first through tube 1113 and the second through tube 1114 to reach an upper portion of the outer shell 111. While drawing in air, the motor 12 expels air from a bottom portion thereof, and the expelled air is discharged through the second air outlet 1123 and the first air outlet 1141. During pet fur grooming, loose pet fur can be carried away by the discharged air.

During pet fur grooming, the first air inlet 1111 is in communication with the third air inlet 1121, and the second air outlet 1123 is in communication with the first air outlet 1141. The side wall of the inner shell 112 blocks the second air inlet 1112 of the outer shell 111, and the side wall of the outer shell 111 blocks the fourth air inlet 1122 of the inner shell 112. When the motor 12 operates, the motor 12 draws in air that enters sequentially through the first air inlet 1111 and the third air inlet 1121. The incoming air passes through a gap between the first through tube 1113 and the second through tube 1114 to reach an upper portion of the outer shell 111. While drawing in air, the motor 12 expels air from a bottom portion thereof, and the expelled air is discharged through the second air outlet 1123 and the first air outlet 1141. During pet fur grooming, loose pet fur can be carried away by the discharged air.

Furthermore, during air duct switching, the inner shell 112 is depressed to move into the movement stroke. At this time, the third air inlet 1121 is blocked by the side wall of the outer shell 111, the first air inlet 1111 is blocked by the side wall of the inner shell 112, and the second air inlet 1112 is in communication with the fourth air inlet 1122. Meanwhile, the second air outlet 1123 is blocked by the side wall of the air outlet tube 114, and the third air outlet 1124 is in communication with the first air outlet 1141. When the motor 12 is activated, the motor 12 draws air into the outer shell 111 through the second air inlet 1112 and the fourth air inlet 1122. The drawn air passes through the gap between the first through tube 1113 and the second through tube 1114 to reach the top of the outer shell 111. The motor 12 expels the air from the bottom thereof, and the expelled air is discharged through the third air outlet 1124 and the first air outlet 1141, thereby completing air duct switching of the pet grooming machine. When one air duct is blocked, the inner shell 112 can be depressed to switch to the other air duct to continue pet fur grooming without interruption, eliminating the need for immediate cleaning of the pet grooming machine, thus achieving efficient and rapid pet grooming and improving convenience of use.

In this preferred embodiment, during pet fur grooming by the pet grooming machine, the motor is activated to draw air into the housing through the first air inlet and the third air inlet, and expel the air through the air outlet of the inner shell. When an air duct is blocked, the inner shell is depressed such that the second air inlet and the fourth air inlet are placed in communication, while the first air inlet and the third air inlet are blocked. The motor is then activated to draw air through the second air inlet and the fourth air inlet and expel the air through the air outlet. The dual-air-duct design allows switching to the other air duct to continue pet fur grooming when one air duct is clogged with pet fur, eliminating the need for immediate cleaning of the pet grooming machine, thereby achieving efficient and rapid pet grooming and enhancing convenience of use.

In conclusion, while the present disclosure has been disclosed herein with reference to preferred embodiments, these preferred embodiments are not intended to limit the present disclosure. A person of ordinary skill in the art may make various changes and modifications without departing from the spirit and scope of the present disclosure. Accordingly, the scope of protection of the present disclosure shall be defined by the appended claims.

1. A pet grooming machine, comprising:
a housing; and
a motor, received in the housing; wherein:
the housing includes an outer shell, and an inner shell moving relative to the outer shell along a movement stroke;
the outer shell defines a first air inlet and a second air inlet that are misaligned;
the inner shell defines:
a third air inlet in communication with the first air inlet;
a fourth air inlet arranged in accordance with the movement stroke and corresponding to the second air inlet; and
an air outlet arranged on a lower side of the inner shell;
wherein, moving the inner shell selectively places either the first air inlet in communication with the third air inlet or the second air inlet in communication with the fourth air inlet.

2. The pet grooming machine according to claim 1, wherein the first air inlet and the second air inlet are opposite each other, and the third air inlet and said fourth air inlet are arranged diagonally.

3. The pet grooming machine according to claim 1, wherein the outer shell comprises a first through-tube, a second through-tube disposed within the first through-tube, and a plurality of first connecting columns connecting the second through-tube to the first through-tube.

4. The pet grooming machine according to claim 3, wherein the second through-tube further includes an installation plate for fixing the motor, and a plurality of second connecting columns connecting the installation plate within the second through-tube.

5. The pet grooming machine according to claim 4, wherein the housing further comprises an air outlet tube connected to one side of the second through-tube, with a first air outlet disposed on the peripheral side of the air outlet tube.

6. The pet grooming machine according to claim 5, wherein the bottom of the inner shell is provided with a concave and hollow cylinder, connected to the installation plate, and the air outlet is disposed on the cylinder.

7. The pet grooming machine according to claim 6, wherein the air outlet comprises a second air outlet and a third air outlet arranged diagonally relative to each other.

8. The pet grooming machine according to claim 3, wherein the housing further comprises an upper cover detachably connected to a top of the first through-tube.

9. The pet grooming machine according to claim 6, wherein a diameter of the cylinder is smaller than that of the air outlet tube, and the cylinder is connected within the air outlet tube.

10. The pet grooming machine according to claim 6, wherein the cylinder has a length greater than that of the air outlet tube and is telescopically connected within the air outlet tube.

11. A pet grooming machine, comprising:
a housing; and
a motor disposed in the housing;
wherein the housing comprising an outer housing and an inner housing movable relative to the outer housing between at least two positions;
the outer housing being provided with a first air inlet and a second air inlet that are staggered relative to each other;
the inner housing being provided with a third air inlet, a fourth air inlet, and an air outlet located at a lower side of the inner housing;
wherein the inner housing, at different positions, places the first air inlet in communication with the third air inlet, or the second air inlet in communication with the fourth air inlet.

12. The pet grooming machine according to claim 11, wherein the first air inlet and the second air inlet are opposite each other, and the third air inlet and said fourth air inlet are arranged diagonally.

13. The pet grooming machine according to claim 11, wherein the outer shell comprises a first through-tube, a second through-tube disposed within the first through-tube, and a plurality of first connecting columns connecting the second through-tube to the first through-tube.

14. The pet grooming machine according to claim 13, wherein the second through-tube further includes an installation plate for fixing the motor, and a plurality of second connecting columns connecting the installation plate within the second through-tube.

15. The pet grooming machine according to claim 14, wherein the housing further comprises an air outlet tube connected to one side of the second through-tube, with a first air outlet disposed on the peripheral side of the air outlet tube.

16. The pet grooming machine according to claim 5, wherein the bottom of the inner shell is provided with a concave and hollow cylinder, connected to the installation plate, and the air outlet is disposed on the cylinder.

17. The pet grooming machine according to claim 16, wherein the air outlet comprises a second air outlet and a third air outlet arranged diagonally relative to each other.

18. The pet grooming machine according to claim 13, wherein the housing further comprises an upper cover detachably connected to a top of the first through-tube.

19. The pet grooming machine according to claim 16, wherein a diameter of the cylinder is smaller than that of the air outlet tube, and the cylinder is connected within the air outlet tube.

20. The pet grooming machine according to claim 16, wherein the cylinder has a length greater than that of the air outlet tube and is telescopically connected within the air outlet tube.
